(19) United States
(12) Patent Application Publication
(10) Pub. No.: US 2006/0244395 A1
(43) Pub. Date: Nov. 2, 2006

(54) Electronic ballast having missing lamp detection

(76) Inventors: Mark S. Taipale, Harleysville, PA (US); Venkatesh Chitta, Center Valley, PA (US); Dragan Veskovic, Allentown, PA (US)

Correspondence Address: LUTRON ELECTRONICS CO., INC.;MARK E. ROSE, 7200 SUTER ROAD, COOPERSBURG, PA, 18036-1299, US

(21) Appl. No.: 11/120,229

(22) Filed: May 2, 2005

(51) Int. Cl. H05B 41/16

(52) U.S. Cl. 315/277

(57) ABSTRACT

An electronic ballast for driving a plurality of gas discharge lamps in parallel includes a rectifier to convert an AC mains input voltage to a rectified voltage, a filter circuit to convert the rectified voltage to a substantially DC bus voltage, an inverter to convert the DC bus voltage to a high-frequency AC voltage for driving the lamp, and an output stage for coupling the high-frequency AC voltage to the lamps. The ballast also includes a plurality of balancing transformers coupled to the lamps for balancing the currents in the lamps. When one of the parallel lamps is missing or faulty, a substantially large voltage is produced across one or more of the balancing transformers. This large voltage is detected by a missing-lamp detect circuit that provides a control signal to a ballast control circuit. In response to a detected missing-lamp condition, the control circuit stops the ballast from driving the lamps. Optionally, the ballast control circuit can transmit a message regarding the missing-lamp condition via an external communication link.

### FIELD OF THE INVENTION

The present invention relates to electronic ballasts and, more particularly, to electronic dimming ballasts for driving a plurality of gas discharge lamps, such as fluorescent lamps, in parallel.

### BACKGROUND OF THE INVENTION

Electronic ballasts for fluorescent lamps typically include a “front end” and a “back end”. The front end typically includes a rectifier for changing alternating-current (AC) mains line voltage to a direct-current (DC) bus voltage and a filter circuit for filtering the DC bus voltage. Electronic ballasts also often include a boost circuit for boosting the magnitude of the DC bus voltage above the peak of the line voltage and for improving the total harmonic distortion (THD) and power factor of the input current to the ballast.

The ballast back end typically includes a switching inverter for converting the DC bus voltage to a high-frequency AC voltage and an output stage comprising a resonant tank circuit for coupling the high-frequency AC voltage to the lamp electrodes. The ballast back end also typically includes a feedback circuit that monitors the lamp current and generates control signals to control the switching of the inverter so as to maintain a desired lamp current magnitude.

Since ballasts are often installed in lighting fixtures containing multiple lamps, electronic ballasts need to be able to drive multiple fluorescent lamps. The lamps may be connected to the ballast either in series or in parallel electrical connection.

Referring first to FIG. 1, there is shown a simplified block diagram of a prior art electronic ballast 100. The ballast 100 includes a rectifier 110 capable of being connected to an AC power supply such as a typical 60 Hz AC main. The rectifier 110 converts the AC input voltage to a rectified pulsating DC voltage. The rectifier 110 is connected to a filter circuit, such as a valley-fill circuit 120, through a diode 122. A high-frequency filter capacitor 124 is connected across the inputs to the valley-fill circuit 120. The valley-fill circuit 120 includes one or more energy storage devices that selectively charge and discharge so as to fill the valleys between successive rectified voltage peaks to produce a substantially DC bus voltage. The DC bus voltage is the greater of either the rectified voltage or the voltage across the energy storage devices in the valley-fill circuit 120.

The outputs of the valley-fill circuit 120 are in turn connected to the inputs to an inverter circuit 140. The inverter 140 converts the rectified DC voltage to a high-frequency AC voltage. The outputs of the inverter 140 are connected to an output circuit 150, which typically includes a resonant tank, and may also include a coupling transformer. The output circuit 150 filters the output of the inverter 140 to supply essentially sinusoidal voltage, as well as provide voltage gain and increased output impedance. The output circuit 150 is capable of being connected to drive a load 180 such as a gas discharge lamp; for example, a fluorescent lamp.

A control circuit 130 generates drive signals to control the operation of the inverter 140 so as to provide a desired load current to the load 180. An output current sense circuit 160 coupled to the load 180 provides load current feedback to the control circuit 130. An over-voltage protection (OVP) circuit 132 detects when the voltage at the output of the resonant tank in the output circuit 150 exceeds a predetermined level and sends a control signal to the control circuit 130 indicative of this over-voltage condition. A power supply 115 is connected across the outputs of the rectifier 110 to provide a supply voltage Vcc, which is used to power the control circuit 130.

FIG. 2 shows a simplified schematic diagram of the back end of a prior art dimming ballast for driving multiple lamps in series. As previously mentioned, the back end includes an inverter 140, an output stage 150, and an output current sense circuit 160. The inverter 140 is connected to the output of the valley-fill circuit 120 and provides the high-frequency AC voltage for driving lamps 280A, 280B. The inverter 140 includes series-connected first and second switching devices 242 and 244. When the rectified voltage is greater than the voltage on the energy-storage devices in the valley-fill circuit 120, then the inverter 140 draws current directly from the AC line. When the rectified voltage is less than the voltage on the energy-storage devices, then the inverter 140 draws current from the energy-storage devices.

The control circuit 130 drives the switching devices 242, 244 of the inverter 140 using a fixed frequency, complementary duty cycle switching mode of operation. This means that one, and only one, of the switching devices 242, 244 is conducting at any given time. When switch 242 is conducting, then the output of the inverter 140 is pulled upwardly toward the bus voltage. When the switching device 244 is conducting, then the output of the inverter 140 is pulled downwardly toward circuit common. The conduction times of the switching devices 242, 244 are controlled by the control circuit 130 in response to the current flowing through the gas discharge lamps 280A, 280B, and a control signal indicative of the desired light level.

The output of the inverter 140 is connected to the output stage 150 comprising a resonant tank circuit including an inductor 252 and a capacitor 254. The output stage 150 filters the inverter 140 output voltage to supply an essentially sinusoidal voltage to the series-connected lamps 280A, 280B. In addition, the output stage 150 provides voltage gain and increased output impedance. By means of a coupling transformer 256, the output of the resonant tank circuit is boosted and coupled to the electrodes of the gas discharge lamps 280A, 280B. A DC blocking capacitor 258 prevents DC current from flowing through the primary winding of the transformer 256.

The ballast also includes a current sense circuit 160 comprising two diodes 262, 264 and a resistor 266, coupled in series with the lamps 280A, 280B. The current sense circuit 160 generates a half-wave rectified voltage that is proportional to lamp current and represents a measure of actual light output. The half-wave rectified voltage is supplied as an input to the control circuit 130 of FIG. 1.

The ballast 100 must be able to provide high output voltages to strike and operate lamps 280A, 280B, but not so high as to damage the ballast. The over-voltage protection (OVP) circuit 132 detects the voltage across the resonant tank capacitor 254 of the output circuit 150 and ensures that the output voltage of the ballast never becomes high enough to damage the ballast or become unsafe. Upon determination of an over-voltage condition, the control circuit 130 will shut the ballast down. When one or more of the series-connected lamps 280A, 280B are missing or faulty, the control circuit 130 will attempt to strike the lamps, thus generating a steadily increasing voltage across the resonant tank capacitor 254. Eventually, the over-voltage protection circuit 132 detects the over-voltage condition and, in response, the control circuit 130 ceases the operation of the ballast. Accordingly, the over-voltage protection circuit 132 provides a means for determining when one ore more of a plurality of lamps connected to the ballast in series is missing, faulty, or damaged.

FIG. 3 shows an output stage 350, a current sense circuit 360, and a balancing circuit 370 of a ballast for driving lamps 380A, 380B, 380C connected in parallel. Once again, the output stage 350 comprises a resonant tank circuit including an inductor 352 and a capacitor 354. The output stage 350 provides an essentially sinusoidal voltage to parallel-connected lamps 380A, 380B, 380C. Since the lamps 380A, 380B, 380C are driven in parallel and a boosted voltage is not required, the output of the resonant tank circuit is simply coupled to the lamps through a DC blocking capacitor 358.

Because the lamps 380A, 380B, 380C are driven in parallel, there can potentially be different currents flowing through each lamp, thus causing the lamps to illuminate at different intensities. Balancing circuit 370 includes balancing transformers 372 and 374 that are provided in order to balance the currents through the lamps 380A, 380B, 380C, and thus, balance the intensities of the lamps. Transformer 372 has a 1:1 turns ratio, such that a first current that is flowing in the first lamp 380A and the first winding of transformer 372 will force a current of the same magnitude in the second winding, and thus, the second lamp 380B. Transformer 374 has a 1:2 turns ratio, but functions similarly to transformer 372. When a combined current from lamp 380A and lamp 380B is flowing through the first winding of transformer 374, a current having half the magnitude of the combined current in the first winding will flow through the second winding, thus balancing the current in the third lamp 380C with the currents in the other lamps 380A, 380B.

An output current sense circuit 360 comprises two diodes 362, 364 and a resistor 366, and, in this case, is in series with the second winding of transformer 374. The output current sense circuit 360 provides a current sense input to the control circuit 130. By simply sensing the current through one of the lamps, the currents through each lamp are known since the balancing circuit 370 balances the currents in the three lamps.

When one of a plurality of lamps being driven in parallel is missing or faulty, there will not be a significant increase in the output voltage across the capacitor 354 of the ballast. An over-voltage protection circuit coupled to the output circuit of the ballast cannot be used to determine the missing-lamp condition. Thus, there exists a need for an electronic ballast for driving lamps in parallel that is operable to determine if one of the lamps is missing or faulty.

### SUMMARY OF THE INVENTION

In accordance with a first feature of the invention, a novel electronic ballast for driving a plurality of gas discharge lamps in parallel includes a rectifier to convert an AC mains input voltage to a rectified voltage, a filter circuit to convert the rectified voltage to a substantially DC bus voltage, an inverter to convert the substantially DC bus voltage to a high-frequency AC voltage signal for driving the gas discharge lamp, an output stage for coupling the high-frequency AC voltage signal to the gas discharge lamps, one or more balancing transformers coupled to the lamps for balancing the currents in the lamps, and a control circuit for controlling the operation of the inverter. The control circuit is responsive to missing-lamp voltages produced by the balancing transformers when one or more of the lamps is missing or faulty.

In a preferred embodiment of the ballast, each balancing transformer includes an auxiliary winding for producing the missing-lamp voltage. The missing-lamp voltages are input to a missing-lamp detect circuit that provides a control signal to the control circuit. In response to a missing-lamp condition, the control circuit causes the ballast to stop driving the lamps.

### BRIEF DESCRIPTION OF THE DRAWINGS

FIG. 1 is a simplified block diagram of a prior art electronic ballast 100;

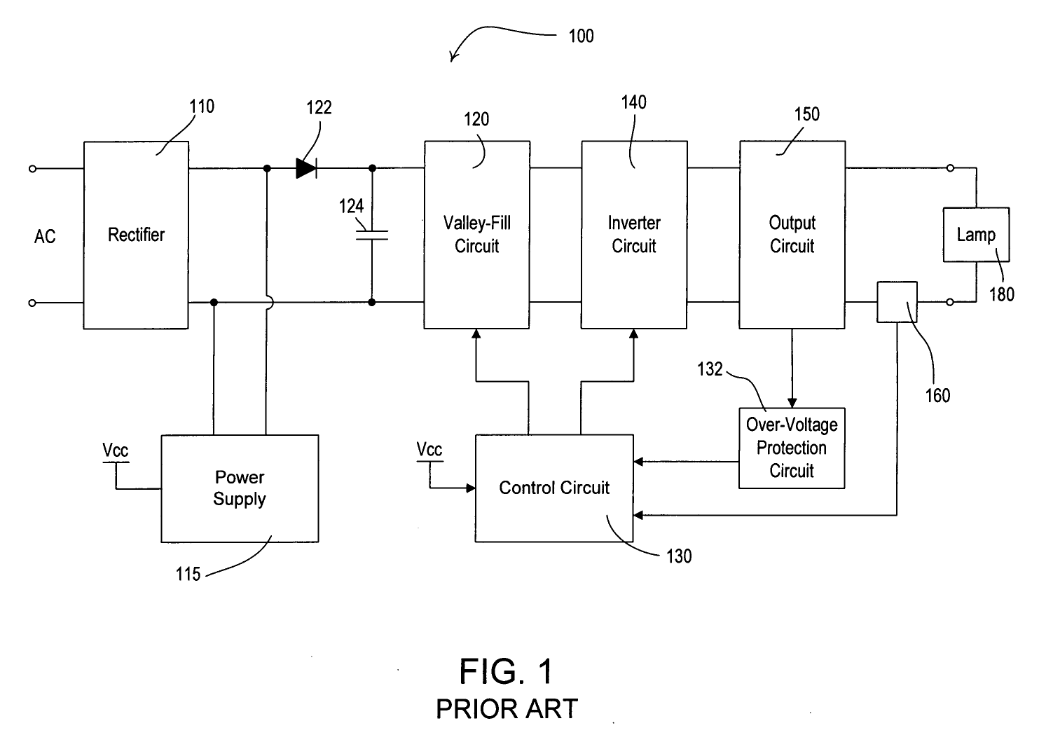

FIG. 2 is a simplified schematic of a prior art back end of ballast 100 for driving lamps in series;

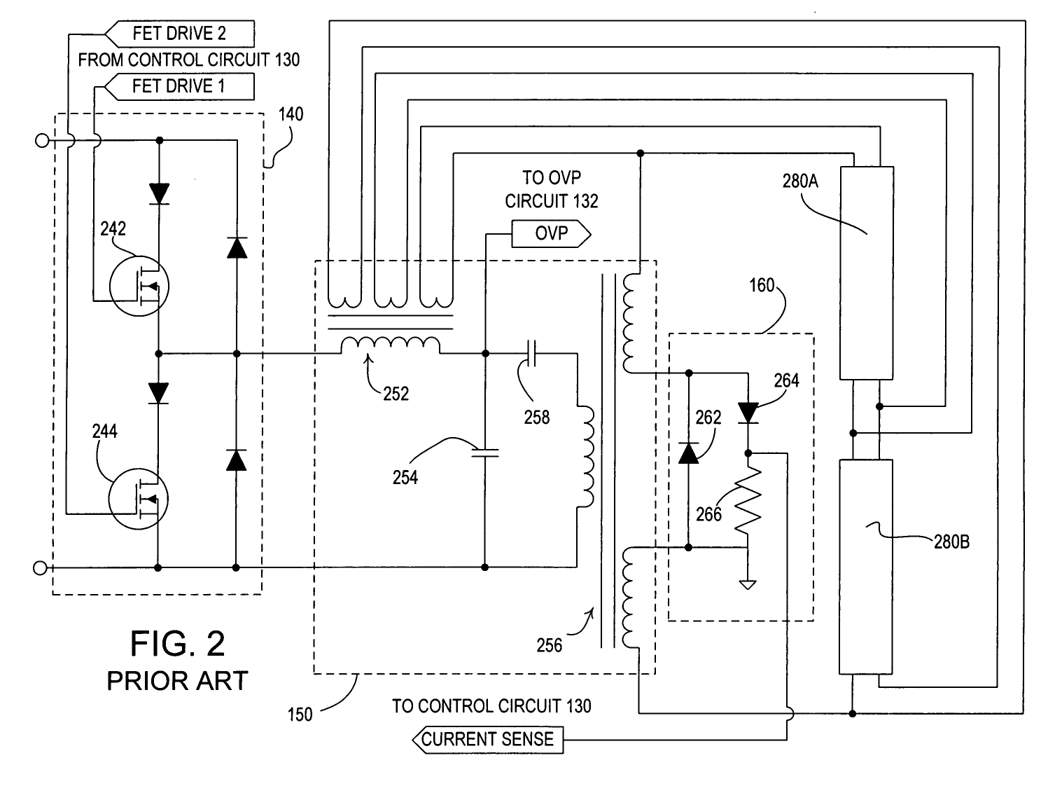

FIG. 3 is a simplified schematic of a prior art back end of ballast 100 for driving lamps in parallel;

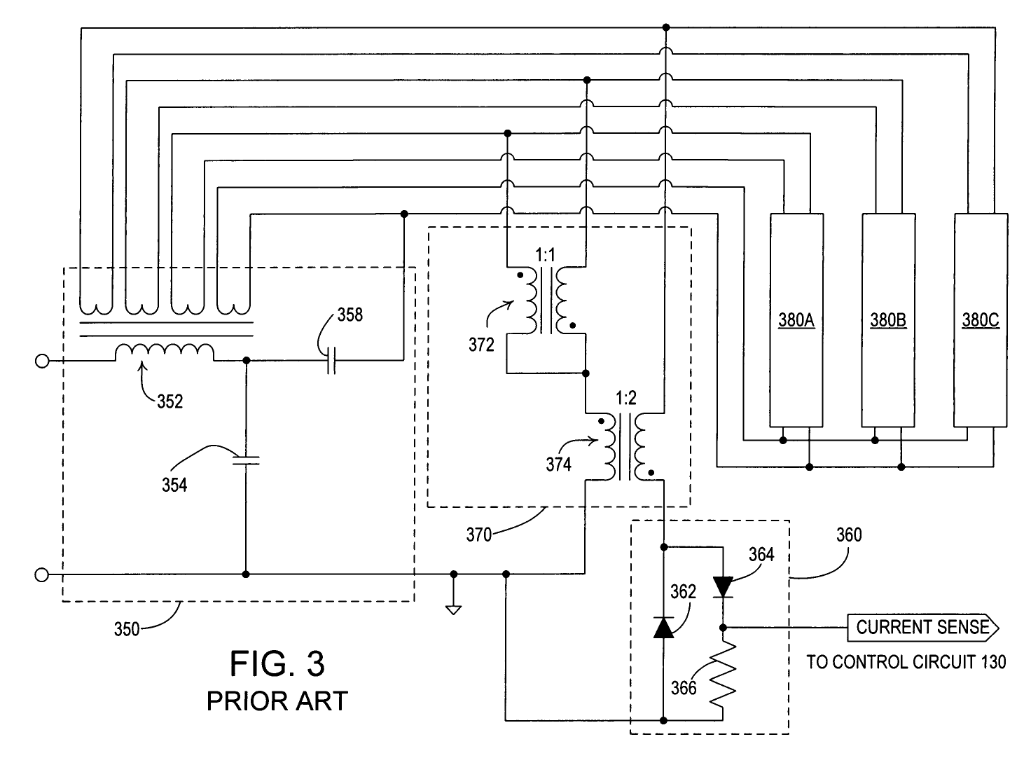

FIG. 4 is a simplified block diagram of an electronic ballast of the current invention;

FIG. 5 is a simplified schematic of an output stage, a current sense circuit, and a balancing circuit of a first embodiment of the current invention;

FIG. 6 is a simplified schematic of a missing-lamp detect circuit of the electronic ballast of the current invention; and

FIG. 7 is a simplified schematic of an output stage, a current sense circuit, and a balancing circuit of a second embodiment of the current invention.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

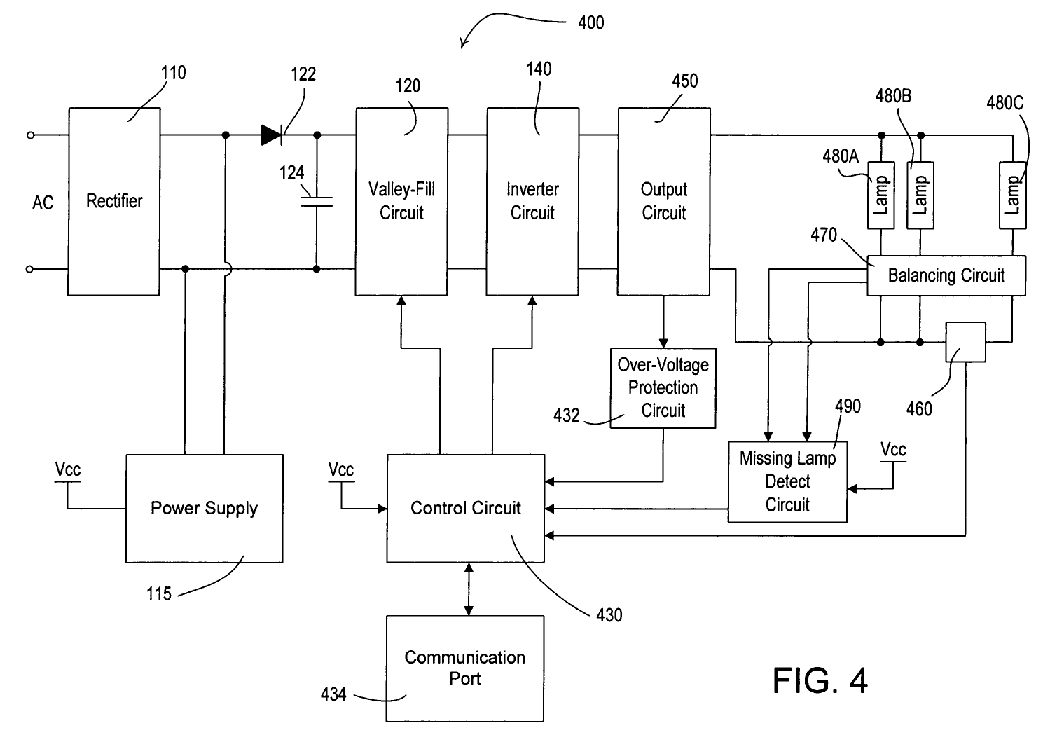

Referring to FIG. 4, there is shown a simplified block diagram of an electronic ballast 400 for driving lamps in parallel constructed in accordance with the invention. An output stage 450 is provided for driving three lamps 480A, 480B, 480C in parallel. An output current sense circuit 460 is connected in series with lamp 480C to provide lamp current feedback to a control circuit 430, which preferably comprises a microprocessor. An over-voltage protection (OVP) circuit 432 detects when the voltage at the output of the output circuit 450 exceeds a predetermined level and sends a control signal to the control circuit 430 indicative of this over-voltage condition. If all of the lamps 480A, 480B, 480C are missing or faulty, a high voltage will be produced at the output of the output circuit 450. The control circuit 430 will shut down the ballast based on the control signal received form the OVP circuit 432.

A balancing circuit 470 is provided in series with the lamps 480A, 480B, 480C to balance the currents in the lamps 480A, 480B, 480C, such that the intensities of all of the lamps are substantially equal. The balancing circuit 470 also provides two outputs to a missing-lamp detect circuit 490. When one of the lamps 480A, 480B, 480C is missing or faulty, the balancing circuit 470 provides a high voltage AC signal on either one of or both of the outputs. If missing-lamp detect circuit 490 receives the high voltage AC signal on either input, then an appropriate control signal is sent to the control circuit 430.

When control circuit 430 receives the control signal indicating the missing-lamp condition, the control circuit turns the ballast off, i.e, stops the operation of the switching devices of the inverter 140, and thus controls the intensity of lamps 480A, 480B, 480C to zero. Further, the control circuit 430 may transmit the status of the lamps (i.e., that a lamp is missing or failed) to an external device (not shown) on a communication link via a communication port 434. An example of a ballast including such a communication port is described in commonly-assigned U.S. patent application Ser. No. 10/824,248, filed Apr. 14, 2004, entitled “Multiple-Input Electronic Ballast With Processor”, which is herein incorporated by reference in its entirety.

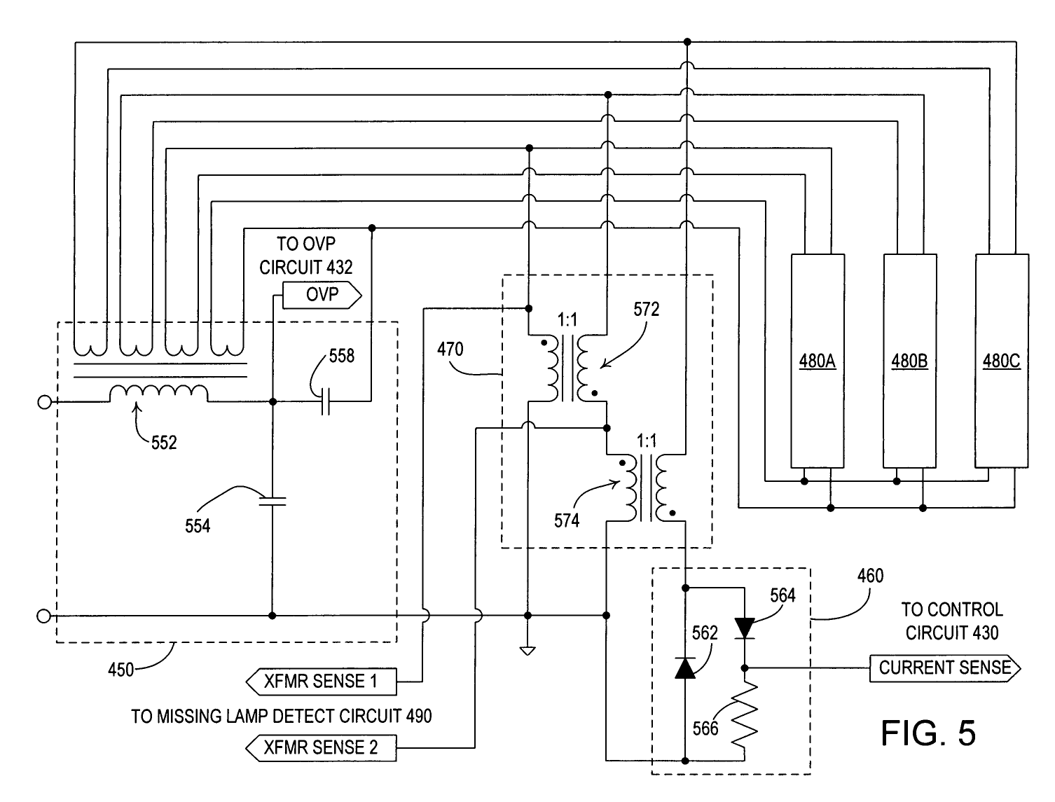

FIG. 5 shows a simplified schematic diagram of a first embodiment of the output stage 450, the output current sense circuit 460, and the balancing circuit 470 of the ballast 400 for driving three lamps 480A, 480B, 480C in parallel. The output stage 450 comprises a resonant tank circuit including an inductor 552 and a capacitor 554 and is coupled to lamps 480A, 480B, 480C via a DC blocking capacitor 558. The voltage across capacitor 554 is provided to the OVP circuit 432 to ensure that the output voltage of the ballast never becomes high enough to damage the ballast or become unsafe.

The other ends of lamps 480A, 480B, 480C are connected to circuit common through balancing circuit 470. When a first current flows through lamp 480A and the first winding of transformer 572, a second current of the same magnitude as the first current flows through lamp 480B and the second winding of transformer 572 and only a small voltage develops across either winding of the transformer. Similarly, when the second current through lamp 480B flows through the first winding of transformer 574, a third current of the same magnitude as the second current flows through lamp 480C and the second winding of transformer 574. Thus, the current of the first lamp 480A is balanced with the current of the second lamp 480B, which is balanced with the current of the third lamp 480C. When there are substantially equal currents flowing through each winding of each transformer 572, 574, only small voltages (approximately 20 volts or less) develop across the windings of either transformer.

The output current sense circuit 460 comprises two diodes 562, 564 and a resistor 566. The output current sense circuit is in series with the second winding of transformer 574 and provides a current sense output to the control circuit 430.

When one of the lamps 480A, 480B, 480C is missing, the current through one winding of balancing transformer 572 or transformer 574, will be zero and thus will not equal the current through the other winding. In this condition, a missing-lamp voltage, having a magnitude larger than the voltage produced across the winding of the transformer during normal operation, will be produced across the windings of the “unbalanced” transformer. For example, if lamp 480A is removed from the circuit, no current will flow through the first winding of transformer 572 while current will still flow through the second winding. Thus, the currents flowing through the windings of transformer 572 will not be equal and the missing-lamp voltage will be produced across the windings of the transformer 572.

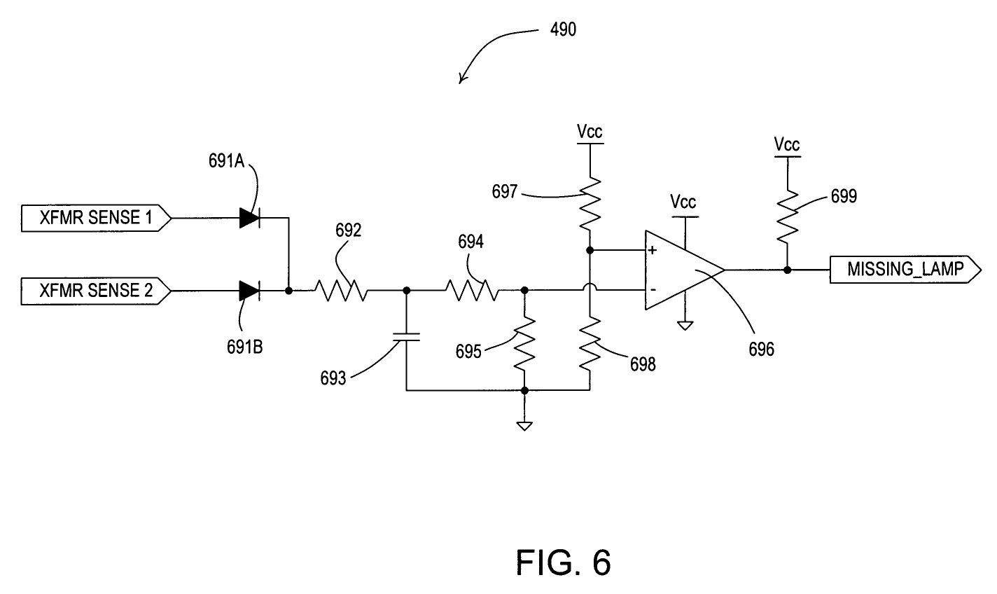

In a first embodiment of the current invention, the missing-lamp voltages are provided to the missing-lamp detect circuit 490, which is shown in more detail in FIG. 6. The voltages produced across the transformers 572, 574 of the balancing circuit 470 are provided through diodes 691A, 691B, respectively. Since the missing-lamp voltages supplied to the missing-lamp detect circuit 490 are high-frequency AC voltages, the voltage at the cathodes of diodes 691A, 691 B is first provided to a low-pass filter, comprising a resistor 692 and a capacitor 693. The diodes 691A, 691B and the low-pass filter transform the high-frequency AC signals into a DC voltage level. Via a resistor divider comprising two resistors 694, 695, the filtered DC voltage is scaled down to an appropriate level (preferably, less than 5 volts) for use by a comparator 696. When the scaled, filtered DC voltage exceeds a reference voltage set by a resistor divider comprising two resistors 697, 698, the comparator 696 drives its output low, signaling a missing-lamp condition to the control circuit 430. Preferably, the reference voltage is set such that the missing-lamp detect circuit 490 signals a missing-lamp condition when the missing-lamp voltage exceeds approximately 50 volts. The output of the comparator 696 is pulled up through a resistor 699 to Vcc.

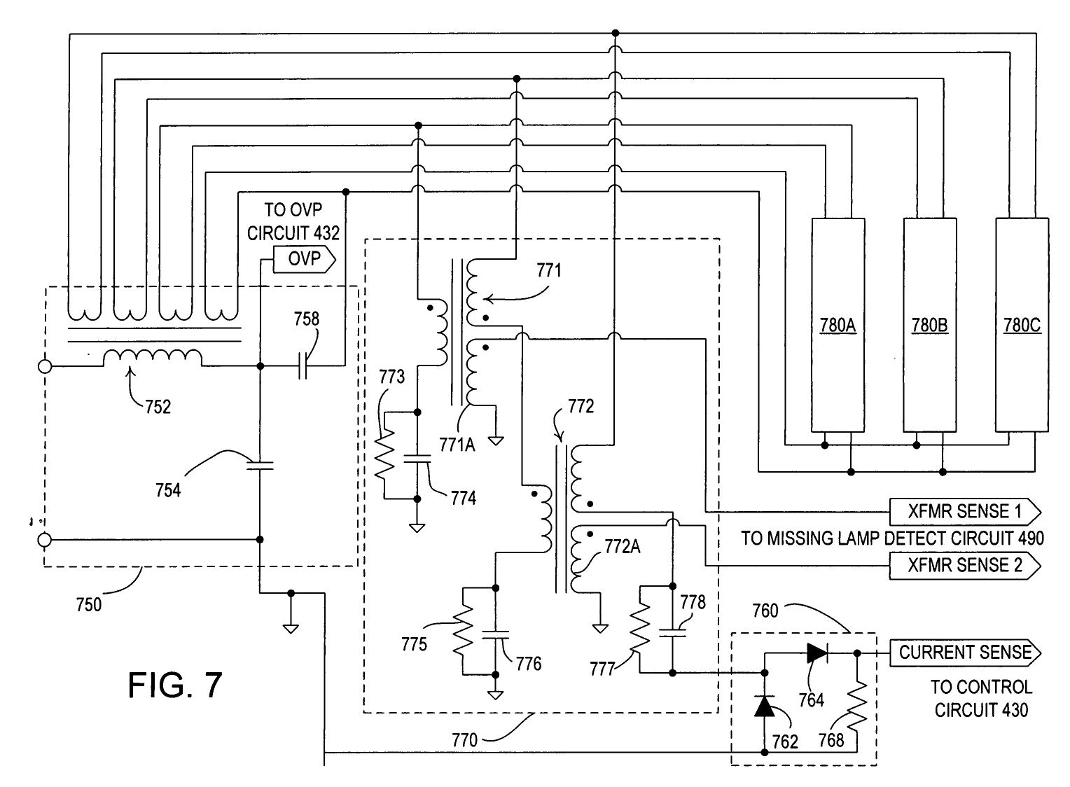

A second embodiment of the back end of the current invention is shown in FIG. 7. An output stage 750 comprises an inductor 752 and two capacitors 754, 758 and operates in the same manner as the output stage 450 of FIG. 5. An output current sense circuit 760, comprising two diodes 762, 764 and a resistor 768, is provided in series with lamp 780C.

A balancing circuit 770 is provided in series with the lamps 780A, 780B, 780C and includes balancing transformers 771, 772. Both transformers 771, 772 have 1:1 turns ratios between their first and second windings. The first winding of transformer 771 is coupled to the first lamp 780A. The second winding of transformer 771 is coupled to the second lamp 780B and the first winding of transformer 772. The second winding of transformer 772 is coupled to the third lamp 780C.

Capacitors 774, 776, 778 are provided to allow for the detection of a DC voltage on the lamps 780A, 780B, 780C and limit the line-frequency (i.e. 60 Hz) current flowing in the lamps the event of a short to ground. Capacitor 774 is provided in series with the first winding of transformer 771. Similarly, capacitor 776 is provided in series with the first winding of transformer 772 (and the second winding of transformer 771) and capacitor 778 is in series with the second winding of transformer 772. Resistors 773, 775, 777 are provided across the capacitors 774, 776, 778, respectively, to allow control circuit 430 to sense the DC level of the voltage across each of the lamps, and thus, detect end-of-life conditions of the lamps. Since the first winding of the transformer 771 and the first winding of transformer 772 are not referenced to circuit common in FIG. 7, the voltages across the windings of both transformers cannot be provided to the missing-lamp detect circuit 490.

In the preferred embodiment of FIG. 7, an auxiliary winding 771A is provided on transformer 771 and an auxiliary winding 772A is provided on transformer 772. Whenever there is an imbalance in the currents flowing through the windings of transformer 771, (or transformer 772), a voltage will develop across auxiliary winding 771A (or auxiliary winding 772A). These voltages are sent to the missing-lamp detect circuit 490. The turns ratio of the auxiliary windings 771A, 772A to the other windings of the transformers 771, 772 can be determined so as to produce a relatively low voltage across the auxiliary windings. Thus, the voltage divider comprising resistors 694, 695 in the missing-lamp detect circuit 490 may be omitted.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An electronic ballast for driving a plurality of gas discharge lamps in parallel from an AC power supply, comprising:
a front end circuit for converting an AC input voltage from said AC power supply to a substantially DC bus voltage;
an inverter for converting said bus voltage to a high-frequency AC drive voltage to drive said lamps;
an output stage for coupling said high-frequency AC drive voltage to said lamps;
a first balancing transformer coupled to two of said plurality of lamps for balancing the current in said two lamps; and
a control circuit responsive to a voltage produced across said balancing transformer operable to control said inverter.

2. The electronic ballast according to claim 1 wherein when one of said plurality of lamps is missing or faulty, a missing-lamp voltage is produced by said balancing transformer.

3. The electronic ballast according to claim 2, further comprising:
a missing-lamp detect circuit coupled to the balancing transformer for receipt of said missing-lamp voltage; said missing-lamp detect circuit operable to provide a control signal representative of said missing-lamp voltage to said control circuit.

4. The electronic ballast according to claim 3, wherein said balancing transformer comprises an auxiliary winding;
wherein said missing-lamp voltage is produced across said auxiliary winding when one of said plurality of lamps is missing or faulty.

5. The electronic ballast according to claim 4, further comprising:
a plurality of capacitors in series with each of said plurality of lamps for reducing the DC component of a current in the lamps.

6. The electronic ballast according to claim 2, wherein said control circuit causes said inverter to stop providing said high-frequency AC drive voltage when said missing-lamp voltage is produced by said balancing transformer.

7. The electronic ballast according to claim 2, wherein said control circuit comprises a microprocessor.

8. The electronic ballast according to claim 7, further comprising:
a communication port coupled to said control circuit for coupling to a communication link;
wherein said control circuit is operable to transmit a message on said communication link when said missing-lamp voltage is produced by said balancing transformer.

9. The electronic ballast according to claim 1, wherein said output stage is operable to drive three gas discharge lamps in parallel;
said first balancing transformer comprising a first winding and a second winding having a 1:1 turns ratio; said first winding coupled to a first lamp of said three lamps and said second winding coupled to a second lamp of said three lamps;
said ballast further comprising:
a second balancing transformer comprising a third winding and a fourth winding having a 1:1 turns ratio; said third winding coupled to said second winding of said first balancing transformer and said fourth winding coupled to a third lamp of said three lamps; said first and second balancing transformers operable to balance the currents in said three lamps;
wherein when said first lamp or said second lamp is missing or faulty, a first missing-lamp voltage is produced by said first balancing transformer, and when said second lamp or said third lamp is missing or faulty, a second missing-lamp voltage is produced by said second balancing transformer.

10. The electronic ballast according to claim 9, further comprising:
a missing-lamp detect circuit for receiving said first and said second missing-lamp voltages and operable to provide a control signal representative of said first or said second missing-lamp voltages to said control circuit.

11. A method for detecting a missing-lamp condition of an electronic ballast comprising a back end for driving a plurality of gas discharge lamps in parallel; the method comprising the steps of:
providing a balancing transformer coupled to two of said plurality of lamps for balancing the currents in said two lamps;
producing a missing-lamp voltage across said balancing transformer when one of said plurality of lamps is missing or faulty; and
detecting said missing-lamp voltage.

12. The method of claim 11, further comprising the step of:
controlling said back end to stop driving said lamps in response to detecting said missing-lamp voltage.

13. The method of claim 11, wherein said ballast is coupled to a communication link; further comprising the step of:
transmitting a message on said communication link when the missing-lamp voltage is detected.

14. The method of claim 11, wherein said balancing transformer comprises an auxiliary winding; and
wherein the step of producing said missing-lamp voltage comprises producing said missing-lamp voltage across said auxiliary winding.
